(19) United States
(12) Patent Application Publication
(10) Pub. No.: US 2017/0130638 A1
(43) Pub. Date: May 11, 2017

(54) SENSOR APPARATUS FOR DETECTING AT LEAST ONE PROPERTY OF A FLUID MEDIUM AND METHOD FOR PROVIDING SAME

(71) Applicant: Robert Bosch GmbH, Stuttgart (DE)

(72) Inventors: Milan Kotynek, Olesnik (CZ); Karel Vacha, Mirkovice (CZ); Joachim Ulrich Brehm, Weinstadt (DE); Sebastian Russ, Rutesheim (DE)

(73) Assignees: Robert Bosch GmbH, Stuttgart (DE); Robert Bosch GmbH, Stuttgart (DE)

(21) Appl. No.: 15/321,101

(22) PCT Filed: Jun. 1, 2015
(86) PCT No.: PCT/EP2015/062088

§ 371 Date: Dec. 21, 2016

(30) Foreign Application Priority Data
Jul. 2, 2014 (DE) 10 2104 212 862.5

(51) Int. Cl. F01N 13/00; G01M 15/10; F01N 13/18

(52) U.S. Cl. CPC F01N 13/008; F01N 13/18; G01M 15/102; F01N 2450/22; F01N 2560/02; F01N 2450/20

(57) ABSTRACT

A sensor apparatus for detecting at least one property of a fluid medium, in particular of an exhaust gas of an internal combustion engine, and to a method for furnishing a sensor apparatus of that kind. The sensor apparatus encompasses at least one protective housing for reception of at least one sensor element in an inner housing, the inner housing being surrounded at least partly by an outer housing. The outer housing is secured with reference to the inner housing by way of a press fit, in particular over a portion. The sensor apparatus according to the present invention exhibits good resistance to thermal shock simultaneously with good sensor element dynamics, and allows an oriented design of the protective housing to be furnished.

### BACKGROUND INFORMATION

Sensor apparatuses for detecting at least one property of a fluid medium, preferably of a gas, include sensor apparatuses having at least one sensor element for detecting at least one parameter of a gas, in particular at least one property of an exhaust gas of an internal combustion engine, for example the concentration of a constituent of the exhaust gas, in particular the oxygen concentration, nitrogen concentration, and/or concentration of gaseous hydrocarbons. Further properties that can be detected with a sensor apparatus of this kind are, for example, the particle load, temperature, and/or pressure of the fluid medium. A sensor apparatus of this kind can be, in particular, a lambda probe. Lambda probes are used preferably in the exhaust gas section of an internal combustion engine, especially in order to detect the oxygen partial pressure in the exhaust gas. Lambda probes are described, for example, in Konrad Reif., ed., Sensoren im Kraftfahrzeug [Sensors in motor vehicles], 2nd edition, Springer Vieweg, pp. 160 to 165.

Sensor apparatuses of this kind possess, in particular at their tip on the exhaust gas side, protective housings that project into the exhaust gas flow. The protective housing itself can be embodied as one part or multiple parts, a multi-part embodiment usually having an internal housing and an external housing surrounding the internal housing, between which is configured a cavity in which further protective tubes are optionally present. Protective housings that have two protective tubes, and are therefore also referred to as a “double protective tube,” are used particularly often.

The protective housings serve for protection from mechanical stresses both upon installation and as a result of particles occurring in the exhaust system, for controlled flow guidance of the fluid medium within the sensor apparatus to the sensor element located therein, and for protection of the sensor element with respect to condensation from the exhaust gas and a thermal shock, associated therewith, to the sensor element. A so-called “thermal shock” occurs in particular when a condensate droplet forms from the exhaust gas flow and deposits onto the hot ceramic sensor element, with the result that local temperature differences are generated on the surface of the sensor element and can result in large thermally induced stresses in the sensor element which ultimately can bring about damage to or even destruction of the sensor element. The protective housing is therefore configured as a rule so as to reduce, if possible to a value that is largely harmless to the sensor element, a load on the sensor apparatus due to liquid occurring in the exhaust system.

The demands on the protective housing are, however, in many cases contradictory. In particular, a conflict of objectives exists in practice between requirements in terms of good protection from thermal shock and in terms of a highly dynamic sensor apparatus. This means in particular that features on the protective housing whose consequence is that a liquid load on the sensor element can be reduced often simultaneously result in a reduction in the dynamics of the sensor apparatus. This is conditioned by the fact that maximally rapid gas exchange in the vicinity of the sensor element generally promotes the dynamics of the sensor apparatus, while at the same time the liquid load on the sensor element is thereby increased, the result being generally that protection from thermal shock is diminished. This means in practice that for a selected protective housing, as a rule only one of the two demands—high dynamics or good protection from thermal shock—can be met in a largely satisfactory manner.

Sensor apparatuses usually used in internal combustion engines exhibit a so-called “unoriented” design of the protective housing. The “unoriented” design of the protective housing is understood as a design according to which the sensor apparatus is introduced into the measured gas space irrespective of the flow direction of the fluid medium, in particular of the exhaust gas. The sensor apparatus accordingly is usually introduced into the exhaust section of the internal combustion engine without considering in that context the flow direction of the exhaust gas present in the exhaust section of the internal combustion engine, for example with reference to a disposition of at least one entrance opening for the fluid medium into the protective housing. On the other hand, it is known that the dynamics of the sensor apparatus depend on a large number of factors, in particular on the details of a configuration of the at least one protective housing in the sensor apparatus, also including the disposition of the entrance openings for the fluid medium into the protective housing.

It would therefore be desirable to furnish a sensor apparatus for detecting at least one property of a fluid medium, in particular of the exhaust gas of an internal combustion engine, which possesses a so-called “oriented” design of the at least one protective housing. This is understood as a design in which the sensor apparatus is aligned in oriented fashion with reference to the flow direction of the exhaust gas in the exhaust section of the internal combustion engine, in particular in order thereby to improve the dynamics of the sensor apparatus. Hitherto, however, there has been no sensor apparatus that possesses a maximally simple design and can be furnished, in a method to be carried out in the simplest possible manner, in the form of an oriented design with reference to the flow direction of the fluid medium in the exhaust section.

### SUMMARY

The present invention provides a sensor apparatus for detecting at least one property of a fluid medium, in particular of an exhaust gas of an internal combustion engine, as well as a method for furnishing a sensor apparatus of this kind, which at least largely overcome the known limitations and disadvantages. A sensor apparatus of this kind serves in particular to detect at least one property of a fluid medium, preferably a property of the exhaust gas of an internal combustion engine, for example the oxygen concentration, nitrogen concentration, and/or concentration of gaseous hydrocarbons in the exhaust gas. The detection of further properties of the fluid medium is, however, conceivable. Because of its configuration, the present sensor apparatus is particularly suitable for use at high temperatures, preferably in the range from 600° C. to 1000° C., but is not limited thereto.

The sensor apparatus according to the present invention encompasses at least one protective housing that is provided for reception of at least one sensor element and that, for that purpose, at least partly surrounds the sensor element. A “protective housing” is to be understood in this context as an apparatus that is configured to protect the sensor element at least with respect to usual mechanical and/or chemical stresses occurring upon installation of the sensor apparatus and/or during operation of the sensor apparatus. The protective housing can be manufactured for this purpose at least partly from a rigid material, in particular a metal and/or an alloy and/or a ceramic, which undergoes no deformation in particular in the context of securing of the protective housing with usual forces, for example usual threading forces. In particular, the protective housing can be configured to enclose the sensor apparatus at least partly on the outside, and thus to give at least a portion of the sensor apparatus an outer conformation. The protective housing can be configured in particular to be introduced entirely or partly into the fluid medium, for example into the exhaust section of an internal combustion engine.

The protective housing can be embodied as one part, two parts, three parts, or multiple parts. According to the present invention the protective housing is embodied in particular as two parts and correspondingly has a separate inner housing that can at least partly surround the sensor element, the inner housing itself being capable of being at least partly surrounded by an outer housing. In this embodiment the inner housing and outer housing can be disposed with respect to one another in such a way that a cavity impingeable upon by the exhaust gas, which preferably can take the shape of an annular gap, is configured between the inner housing and the outer housing.

A flow path through which the fluid medium is capable of flowing can be located inside the protective housing. A “flow path” is understood as that route which the fluid medium can travel, from an entrance into the protective housing to an exit from the protective housing, before the medium can, subsequently thereto, impinge upon the sensor element. In addition to a velocity with which the fluid medium enters the protective housing, this route is defined substantially by a geometric configuration of the cavity within the protective housing. Independently of an actual movement of individual particles and/or molecules in the fluid medium, which can assume both a laminar and a turbulent state on a microscopic scale, on a macroscopic scale the fluid medium can nevertheless follow an (albeit idealized) flow path that proceeds along inner walls within the protective housing and inserts that may be present therein. A configuration of the flow path within the protective housing can thus be defined by a geometry of the configuration of the protective housing, including the entrance openings present therein for entrance of the fluid medium into the cavity of the protective housing, the access openings present therein for access of the fluid medium from the cavity to the sensor element, and optionally additional inserts present in the cavity.

According to the present invention, the outer housing is secured with reference to the inner housing by way of a press fit, in particular by way of a light press fit. “Securing by way of a press fit” is understood with reference to the present invention to mean in particular that the outer housing, which can preferably be locally configured cylindrically, surrounds the inner housing, which can likewise preferably be locally configured cylindrically, at least in a portion, in such a way that in the relevant portion in which the press fit acts between the two parts, a cavity substantially no longer remains between the outer housing and the inner housing, so that the inner side of the surface of the outer housing abuts firmly against the surface of the outer side of the inner housing in the relevant portion of the press fit, the two parts that are secured with respect to one another by way of the press fit nevertheless being mounted displaceably with respect to one another and, in particular, also rotatably with respect to one another upon application of an external pressure. The press fit, in particular the light press fit (the nature of the press fit being capable of being characterized in particular by a magnitude of an external pressure to be applied in order to configure the press fit), thus does not result in complete securing of the two relevant parts with respect to one another, but instead enables a controlled further modification of the relative position of the two parts with respect to one another, in particular a displacement and/or rotation of at least one of the two parts, by application of a selected external pressure.

In a particularly preferred embodiment the outer housing furthermore possesses at least one retaining element, which can be configured, for example, in the form of a protruding lug and can be provided in particular in order to introduce the outer housing into a separate weld nipple and, in a particularly preferred embodiment, to secure it with reference to the weld nipple. The weld nipple can have for this purpose, in particular, a snap-in position in which the retaining element secures the outer housing after introduction thereof into the weld nipple. A “weld nipple” is understood as any mechanical component that can be used to receive a first component (here the outer housing) in order to mount the latter onto a further component, here a sensor housing described below, in such a way that the first component can be secured with reference to the second component by way of the weld nipple.

In a further preferred embodiment the sensor element furthermore possesses a sensor housing; according to the present invention the sensor housing can be fixedly connected to the inner housing, preferably by way of a weld bead that can be applied, for example, between the sensor housing and the inner protective housing. The “sensor housing” is understood here in particular as a protective apparatus for the sensor element which can at least partly surround the sensor element in addition or alternatively to the inner housing.

In particular in the embodiment described above, in which the outer housing still possesses the at least one retaining element for introduction into the weld nipple, the sensor apparatus can preferably be embodied in such a way that the outer housing can furthermore be secured with reference to the sensor housing by way of the weld nipple. Because the sensor housing is fixedly connected to the inner housing in this embodiment, further securing of the outer housing with reference to the inner housing can thereby be accomplished.

In a further preferred embodiment the sensor housing can possess a sealing ring, the sealing ring being embodied in such a way that it thereby becomes possible for the weld nipple to be secured with reference to the sealing ring. What can be achieved in this fashion is in particular that the sensor housing, which at least partly surrounds the sensor element, cannot detach from the protective housing that encompasses the inner housing and the outer housing, which can be secured with reference to the weld nipple by way of the at least one retaining element. It is thereby possible in particular to achieve an oriented design of the sensor apparatus, i.e., an alignment of the protective housing with reference to the flow direction of the fluid medium in the exhaust section.

In a further preferred embodiment the outer housing can enclose the inner housing, in particular in those regions in which the outer housing is secured with reference to the inner housing by way of the press fit, in such a way that a cavity can be constituted between the outer housing and the inner housing. In particular in order to enable constitution of the above-described flow path for the fluid medium within the protective housing, the outer housing can possess at least one entrance opening for the fluid medium from the measured gas space into the cavity, and the inner housing can possess at least one access opening for the fluid medium from the cavity to the sensor element.

In particular in order to enable the above-described oriented design of the sensor apparatus, the outer housing can have for this purpose an enveloping surface, and the entrance opening for the fluid medium can be located in the enveloping surface of the outer housing; in this embodiment the inner housing can also have an enveloping surface, and the access opening for the fluid medium from the cavity to the sensor element can be located in the enveloping surface of the inner housing. As a result, the flow path in the protective housing of the sensor apparatus can be embodied in particular in such a way that it can result in a highly dynamic sensor apparatus simultaneously with a reduced loading of the sensor element with liquid from the fluid medium.

In a further aspect the present invention relates to a method for furnishing a sensor apparatus for detecting at least one property of a fluid medium, in particular of an exhaust gas of an internal combustion engine. The sensor apparatus encompasses in this context at least one protective housing for reception of at least one sensor element in an inner housing, the inner housing being surrounded at least partly by an outer housing.

The method according to the present invention encompasses in particular the method steps a) to d) described below, which preferably are carried out in the sequence described, beginning with a), followed first by b), then by c), and ending with d); one or more of the aforesaid or further method steps can be executed at least partly with a preceding or subsequent method step.

According to step a) the outer housing of the protective housing is inserted into a weld nipple, the outer housing possessing at least one retaining element for introduction into the weld nipple.

According to step b) the weld nipple, with the outer housing inserted thereinto, is placed onto the inner housing with a press fit.

According to step c) the outer housing placed onto the inner housing is slid over the inner housing, while maintaining the press fit, until the at least one retaining element present in the outer housing has reached an associated snap-in position in the weld nipple. Thanks to this type of installation the inner housing can act, in particular, as a support for the outer housing.

According to step d) the inner housing, functioning as a support for the outer housing, is rotated until the at least one retaining element present in the outer housing is inserted into the above-described snap-in position in the weld nipple. The outer housing is thereby secured according to the present invention with reference to the inner housing.

In a particularly preferred embodiment the weld nipple in which the outer housing is inserted in accordance with step a) can be secured by way of a sealing ring. The sealing ring is in this context preferably mounted onto a sensor housing; the sensor housing can be connected, preferably fixedly, for example by way of a weld bead, to the inner housing. The outer housing can in that manner be secured by way of the sensor housing in the weld nipple, and the sealing ring mounted onto the sensor housing can prevent detachment of the sensor housing, in which the sensor element can be located, from the protective housing, which can encompass the outer housing and the inner housing secured thereto by way of a press fit. The outer housing can in that manner be oriented with reference to the flow direction of the exhaust gas with the aid of the at least one retaining element in the outer housing, which can be inserted in the at least one snap-in position of the weld nipple. An orientation according to the present invention of the sensor apparatus with reference to the flow direction of the exhaust gas can thereby be possible, since the welding of the outer housing onto the probe housing, which usually occurs in accordance with the existing art, can be omitted.

For further details regarding the method according to the present invention, reference is made to the description above and/or below with reference to the sensor apparatus.

The sensor apparatus according to the present invention and the associated method for furnishing it may make possible in particular an orientation of the at least one protective housing of the sensor apparatus with reference to the flow direction of the exhaust gas, with the result that the above-described dynamic properties of the sensor apparatus can be improved while simultaneously, in particular with a suitable design of the configuration of the outer housing, water entry into the sensor housing can be decreased. Because of the enhanced dynamics and the simultaneously enhanced resistance to water impingement, a sensor apparatus according to the present invention can already assume its operating mode sooner after an engine start has occurred; this can be used, in particular, to decrease exhaust emissions.

### BRIEF DESCRIPTION OF THE DRAWINGS

Exemplifying embodiments of the present invention are depicted in the Figures and are explained in more detail below.

FIG. 1 is a schematic depiction, in the form of a sectional view, of a sensor apparatus according to the present invention during the method according to the present invention for furnishing it.

FIG. 2 is a schematic depiction, in the form of a sectional view, of the method according to the present invention for furnishing the sensor apparatus according to the present invention.

FIG. 3 is a schematic depiction, in the form of a sectional view, of an outer housing of a sensor apparatus according to the present invention having a retaining element for securing into a weld nipple.

FIG. 4 schematically depicts a sensor apparatus according to the present invention in a plan view, showing a) an unoriented design (existing art) and b) an oriented design of the protective housing.

### DETAILED DESCRIPTION OF EXAMPLE EMBODIMENTS

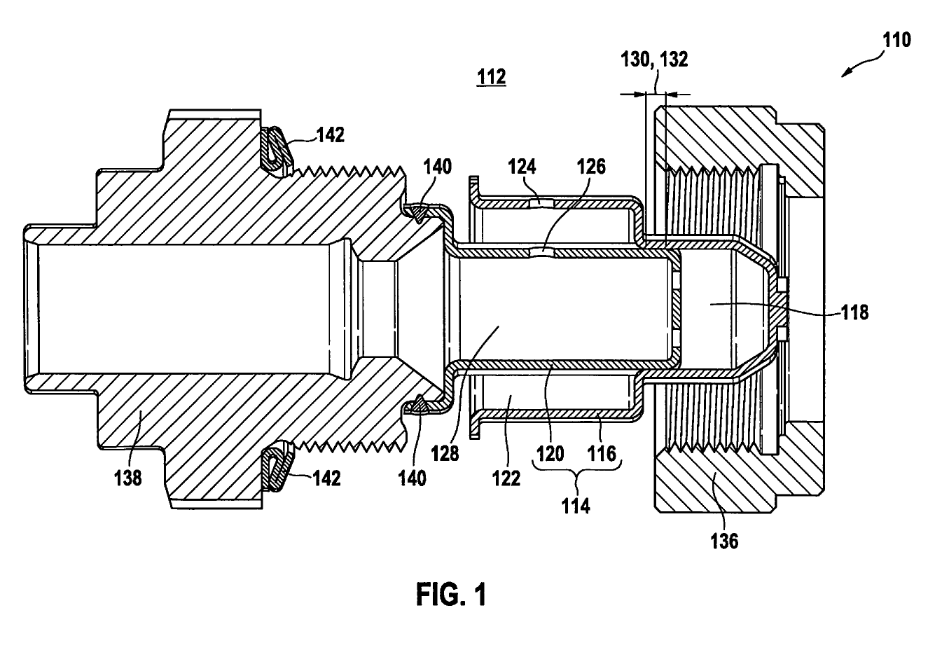

FIG. 1 depicts, in the form of a sectional view, a sensor apparatus 110 according to the present invention for detecting at least one property of a fluid medium 112, during the method according to the present invention for furnishing it. Sensor apparatus 110 encompasses a protective housing 114 for the reception of at least one sensor element (not depicted) which is surrounded by protective housing 114.

In the preferred exemplifying embodiment depicted in FIG. 1, protective housing 114 encompasses an outer housing 116 that has a hollow space 118, embodied in the form of a dome, into which an inner housing 120 is introduced. Outer housing 116 encloses inner housing 120 in such a way that a cavity 122 is constituted between outer housing 116 and inner housing 120. Further embodiments of protective housing 114 for protecting the at least one sensor element of sensor apparatus 110 are, however, possible.

Outer housing 116 of protective housing 114 of sensor apparatus 110 possesses at least one entrance opening 124 through which a fluid medium 112 can enter from the exhaust gas space into cavity 122 between outer housing 116 and inner housing 120. Within protective housing 114, fluid medium 112 is guided on a flow path to an access opening 126 to an inner space 128 of inner housing 120 in which the sensor element (not depicted) is located.

According to the present invention, outer housing 116 is secured with reference to inner housing 120, over a portion 130, by way of a light press fit 132. In this preferred exemplifying embodiment the outer housing is secured by way of a retaining element 134 (not depicted in FIG. 1) with reference to a weld nipple 136.

The preferred exemplifying embodiment of sensor apparatus 110 which is depicted in FIG. 1 furthermore has a sensor housing 138 that surrounds the sensor element (not depicted) and is fixedly connected to inner housing 120 by way of a weld bead 140. Sensor housing 138 here furthermore possesses a sealing ring 142 for later securing of weld nipple 136 onto sensor housing 138.

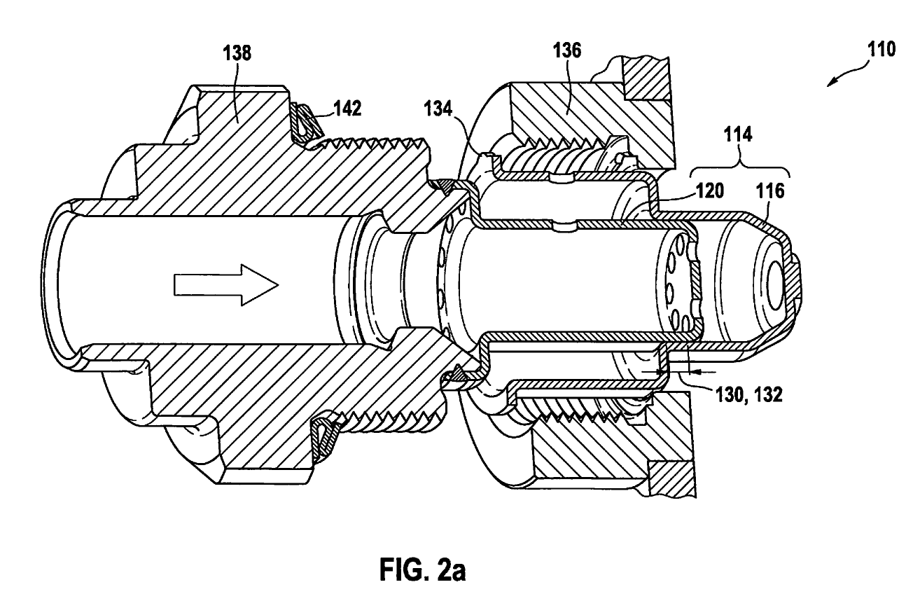

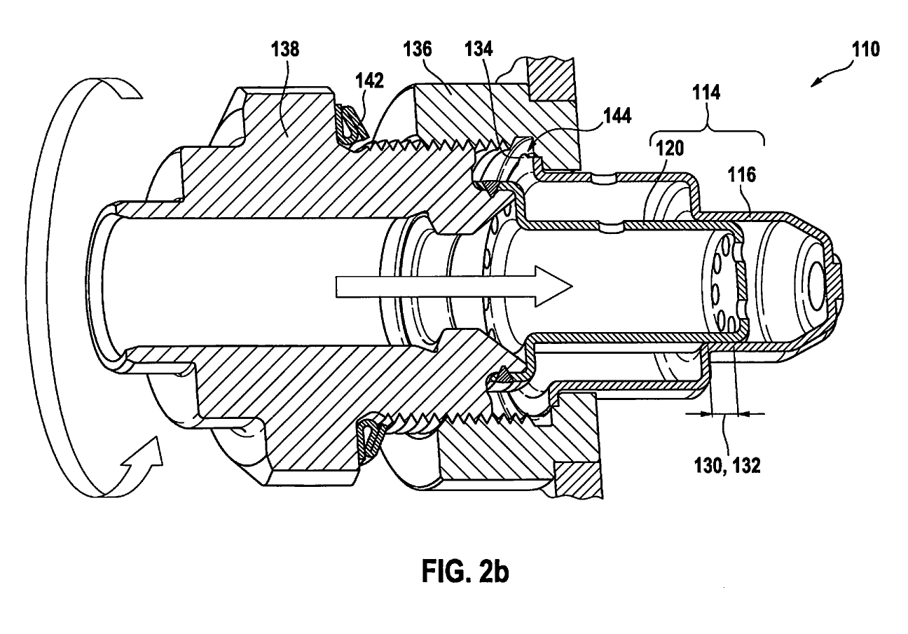

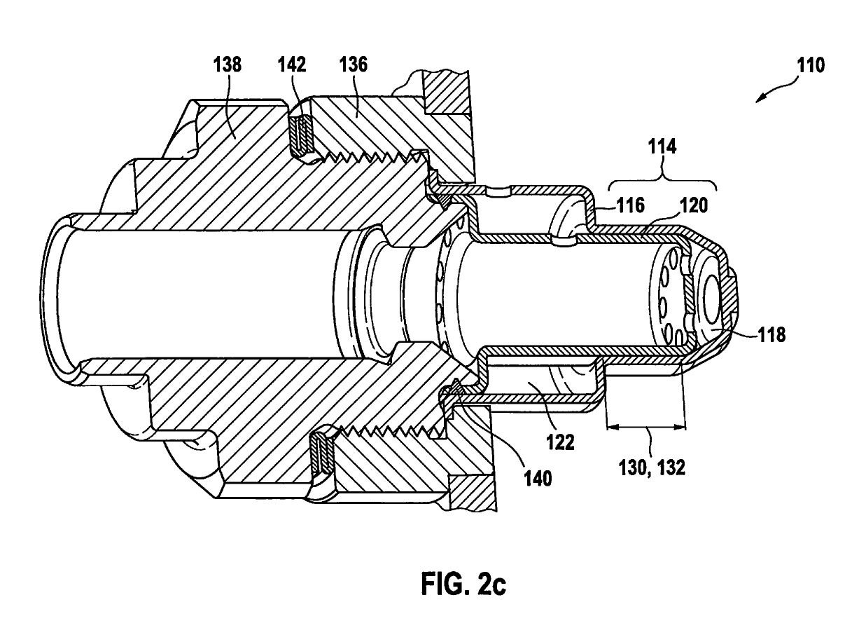

FIG. 2 schematically depicts, in the form of a sectional view, the method according to the present invention for furnishing sensor apparatus 110 according to the present invention.

FIG. 2a) schematically depicts method steps a) and b). According to step a), outer housing 116 of sensor apparatus 110 is inserted into weld nipple 136. Outer housing 116 has in this context a retaining element 134 for securing outer housing 116 in weld nipple 136. According to step b), weld nipple 136 along with outer housing 116 is placed onto inner housing 120 by way of a press fit 132 over a portion 130.

FIG. 2b) schematically depicts the further method steps c) and d). According to step c), outer housing 116 is slid over inner housing 120, maintaining press fit 132 over portion 130, until retaining element 134 in outer housing 116 has reached a snap-in position 144 in weld nipple 136. According to step d), inner housing 120 is rotated until retaining element 134 is inserted into snap-in position 144 in weld nipple 136.

Outer housing 116 is thereby secured with reference to inner housing 120, as depicted in FIG. 2c). As depicted in FIG. 2c), sensor housing 138 here possesses sealing ring 142, which ensures that weld nipple 136 is secured with reference to sealing ring 142. Weld nipple 136 furthermore ensures that outer housing 116 continues to be secured with reference to sensor housing 138 that is fixedly connected to inner housing 120 by way of weld bead 140. Sensor apparatus 110 according to the present invention, which is additionally preloaded by way of sealing ring 142, is thereby furnished as shown schematically in FIG. 2c).

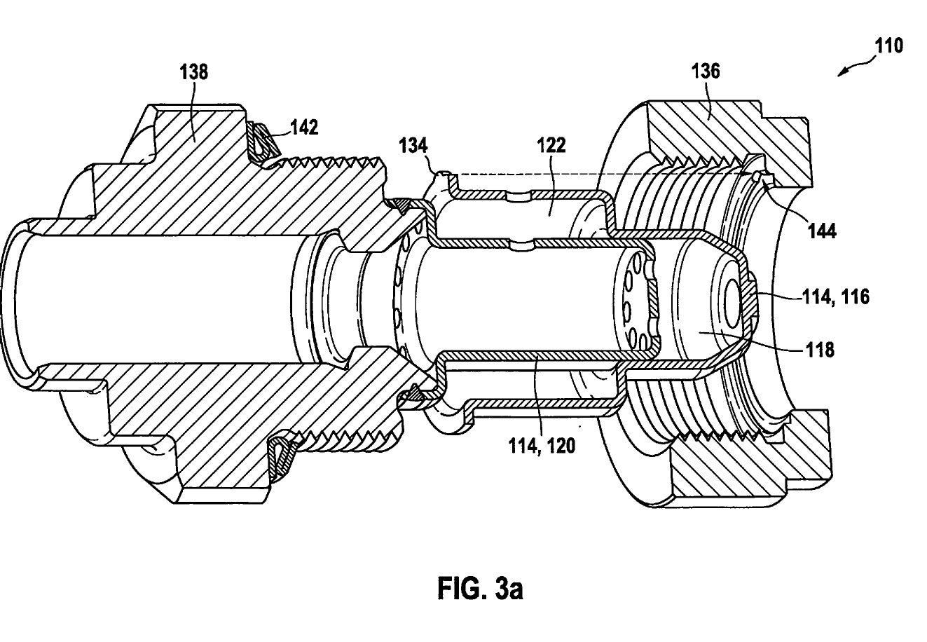

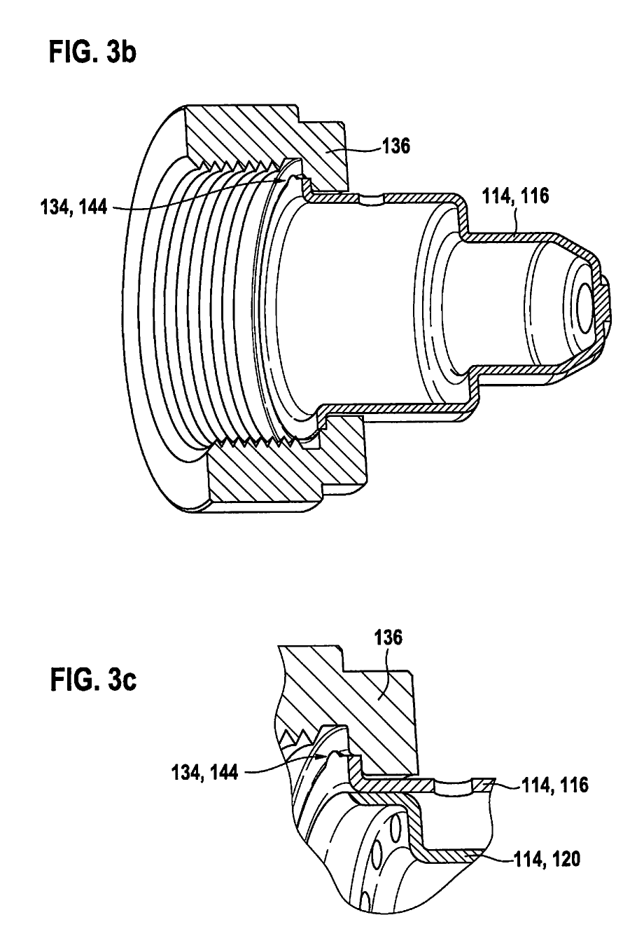

FIG. 3 schematically depicts, in the form of a sectional view, an outer housing 116 of a protective housing 114 of sensor apparatus 110 according to the present invention that possesses a retaining element 134 for securing outer housing 116 in weld nipple 136. In the present preferred exemplifying embodiment, retaining element 134 is configured in the form of a protruding lug that enables outer housing 116 to snap into snap-in position 144 in weld nipple 136. This is evident by way of example from FIGS. 3a) to c), in which retaining element 134 of outer housing 116 is depicted, successively enlarged, in the respective snap-in position 144 in weld nipple 136.

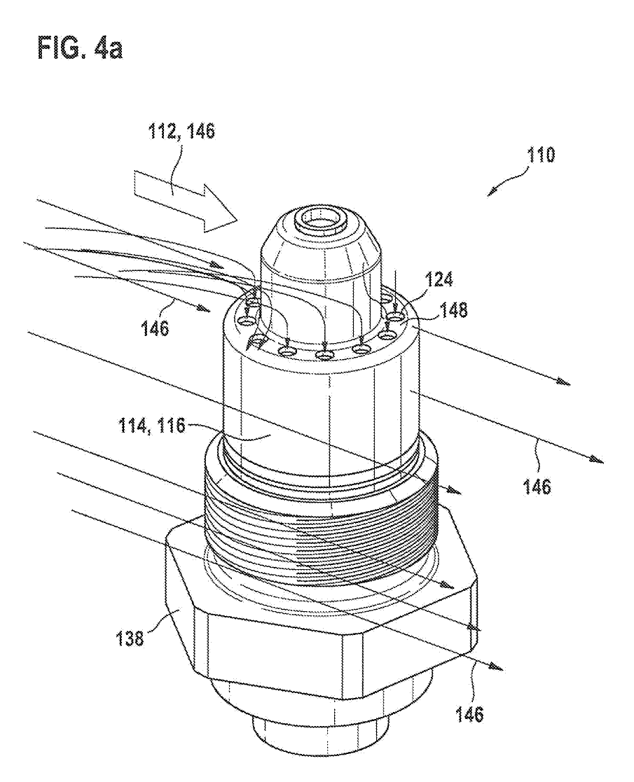

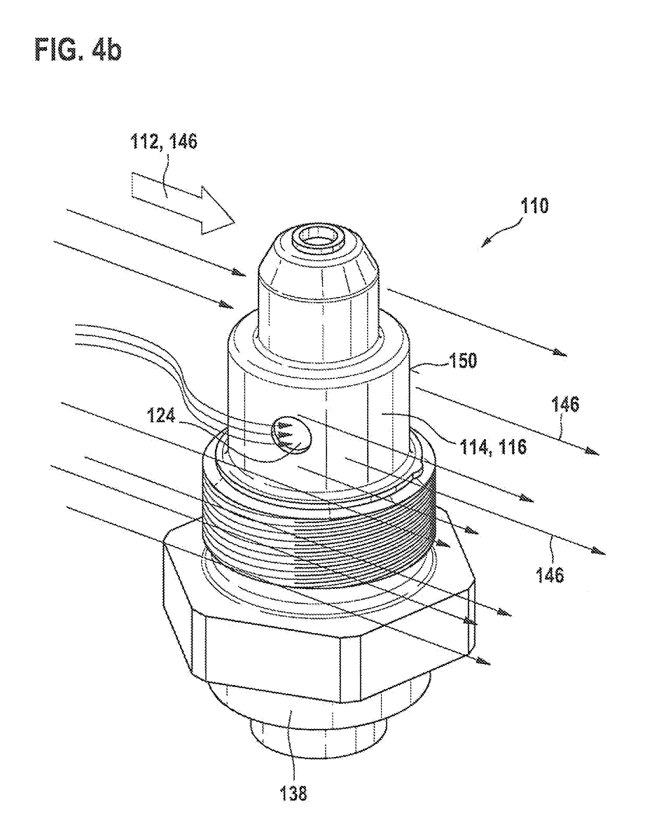

FIG. 4a) schematically depicts a sensor apparatus according to the related art which exhibits an unoriented design with reference to flow direction 146 of fluid medium 112. Entrance openings 124 here are located on a shoulder 148 of outer housing 116, with the result that only a disordered entrance of fluid medium 112 from the measured gas space into sensor apparatus 110 is enabled.

According to the present invention, however, as depicted schematically in FIG. 4b) in the form of a plan view of sensor apparatus 110, the at least one entrance opening 124 is located on an enveloping surface 150 of outer housing 116, which is configured cylindrically in this preferred exemplifying embodiment. The oriented design of protective housing 114 made possible in this fashion improves the dynamic properties of sensor apparatus 110, while at the same time, with a suitable design of the geometry of outer housing 116, less water can penetrate into sensor apparatus 110.

1-10. (canceled)

11. A sensor apparatus for detecting at least one property of a fluid medium, comprising:
at least one protective housing to receive at least one sensor element in an inner housing, the inner housing being surrounded at least partly by an outer housing, wherein the outer housing is secured with reference to the inner housing by way of a press fit.

12. The sensor apparatus as recited in claim 11, wherein the fluid medium is an exhaust gas of an internal combustion engine.

13. The sensor apparatus as recited in claim 11, wherein the outer housing has at least one retaining element for securing in a weld nipple.

14. The sensor apparatus as recited in claim 13, wherein the outer housing is secured with reference to the weld nipple by way of the retaining element.

15. The sensor apparatus as recited in claim 11, wherein the sensor element has a sensor housing, the sensor housing being fixedly connected to the inner housing by way of a weld bead.

16. The sensor apparatus as recited in claim 13, wherein the outer housing is secured with reference to the sensor housing by way of the weld nipple.

17. The sensor apparatus as recited in claim 13, wherein the sensor housing has a sealing ring, the weld nipple being secured with reference to the sensor housing by way of the sealing ring.

18. The sensor apparatus as recited in claim 11, wherein the outer housing partly encloses the inner housing in such a way that a cavity is constituted, the outer housing having at least one entrance opening for the fluid medium into the cavity, the inner housing having at least one access opening for the fluid medium from the cavity to the sensor element.

19. The sensor apparatus as recited in claim 18, wherein the outer housing has an enveloping surface, the entrance opening for the fluid medium being located in the enveloping surface and the inner housing having a further enveloping surface, the access opening for the fluid medium from the cavity being located in the further enveloping surface.

20. A method for furnishing a sensor apparatus for detecting at least one property of a fluid medium, the fluid medium being an exhaust gas of an internal combustion engine, the sensor apparatus including at least one protective housing to receive at least one sensor element in an inner housing, the inner housing being surrounded at least partly by an outer housing, the method comprising:
a) inserting the outer housing into a weld nipple, the outer housing having at least one retaining element for securing the outer housing in the weld nipple;
b) placing the weld nipple, with the outer housing inserted thereinto, onto the inner housing with a press fit;
c) sliding the outer housing over the inner housing, while maintaining the press fit, until the retaining element in the outer housing has reached a snap-in position in the weld nipple; and
d) rotating the inner housing until the retaining element is inserted into the snap-in position in the weld nipple, with the result that the outer housing is secured with reference to the inner housing.

21. The method as recited in claim 20, wherein the weld nipple is secured by way of a sealing ring, the sealing ring being mounted onto a sensor housing, the sensor housing being connected by way of a weld bead, to the inner housing.
